(19) United States
(12) Patent Application Publication
(10) Pub. No.: US 2026/0228470 A1
(43) Pub. Date: Aug. 6, 2026

(54) Indicia Reader with Indicators for Document Placement

(71) Applicant: Zebra Technologies Corporation, Lincolnshire, IL (US)

(72) Inventors: Matthew Lawrence Horner, Sound Beach, NY (US); Steven D. Sieckowski, Port Jefferson, NY (US); Jonathan E. Brady, Port Jefferson Station, NY (US); Yuri Astvatsaturov, Lake Forest, IL (US)

(73) Assignee: Zebra Technologies Corporation, Lincolnshire, IL (US)

(21) Appl. No.: 19/046,272

(22) Filed: Feb. 5, 2025

(51) Int. Cl. G06K 7/10

(52) U.S. Cl. CPC G06K 7/10831; G06K 7/10881

(57) ABSTRACT

An example indicia reader includes a housing having a window that is transparent and a generally planar surface that is opaque and surrounds the window. A camera is positioned within the housing and has a field-of-view (FOV) that is directed through the window. A plurality of indicators are arranged on the generally planar surface to signify an area in which a documents can be placed so that the document is within the FOV of the camera.

### BACKGROUND

Indicia readers (e.g., barcode scanners), such as those used in retail applications, are increasingly being required to cover data capture on adjacent use cases, such as document (e.g., identification card) capture. However, the fields-of-view necessary for reading indicia (e.g., barcodes) and for data capture activities may not always align. For example, indicia readers can be designed such that the field-of-view is pitched to image a leading edge of a product with a barcode on it. This orientation of the field-of-view may confuse a user attempting to position a document on the indicia reader for capture as the user would naturally place the document in the middle of window. However, positioning the document in the middle of window may not position the entire document within the field-of-view and may result in a portion of the document being cut off and not being captured. In certain applications that require optical character recognition to be performed on specific fields of the document, or that require verification of specific holographic features of the document, the document may need to be in a specific portion of the field-of-view, which may not be obvious to the user.

### SUMMARY

In an embodiment, the present invention is an indicia reader, including a housing having a window that is transparent and a generally planar surface that is opaque and surrounds the window. A camera is positioned within the housing and has a field-of-view (FOV) directed through the window. A plurality of indicators are arranged on the generally planar surface to signify an area in which a document can be placed so that the document is within the FOV of the camera.

In a variation of this embodiment, the FOV has a first FOV boundary and a second FOV boundary, diametrically opposed to and generally parallel to the first FOV boundary. The area indicated by the plurality of indicators has a first indicator boundary that is coextensive with the first FOV boundary at the window and a second indicator boundary, diametrically opposed and generally parallel to the first indicator boundary, that is coextensive with the second FOV boundary at the window.

In another variation of this embodiment, a first distance between the first FOV boundary at the window and the second FOV boundary at the window is equal to a second distance between the first indicator boundary and the second indicator boundary.

In another variation of this embodiment, the FOV has a first FOV boundary and a second FOV boundary, diametrically opposed to and generally parallel to the first FOV boundary. The area indicated by the plurality of indicators has a first indicator boundary that is offset from the first FOV boundary at the window a first predetermined distance and a second indicator boundary, diametrically opposed and generally parallel to the first indicator boundary, that is offset from the second FOV boundary at the window a second predetermined distance.

In another variation of this embodiment, a first distance between the first FOV boundary at the window and the second FOV boundary at the window is greater than a second distance between the first indicator boundary and the second indicator boundary.

In another variation of this embodiment, the first indicator boundary and the second indicator boundary are both positioned between the first FOV boundary at the window and the second FOV boundary at the window.

In another variation of this embodiment, each of the plurality of indicators is one of a straight line or a generally L-shaped line.

In another variation of this embodiment, a central axis of the FOV is non-perpendicular to the window.

In another variation of this embodiment, an indicator transverse axis of the area indicated by the plurality of indicators is offset from a FOV transverse axis of the FOV at the window.

In another embodiment, the present invention is an indica reader including a housing having a window that is transparent and a generally planar surface that is opaque and surrounds the window. A camera is positioned within the housing and has a FOV directed through the window. A plurality of indicators are arranged on the window and are positioned outside of a perimeter of the FOV at the window to signify an area in which a document can be placed so that the document is within the FOV of the camera.

In a variation of this embodiment, the FOV has a first FOV boundary and a second FOV boundary, diametrically opposed to and generally parallel to the first FOV boundary. The area indicated by the plurality of indicators has a first indicator boundary that is coextensive with the first FOV boundary at the window and the area indicated by the plurality of indicators has a second indicator boundary, diametrically opposed and generally parallel to the first indicator boundary, that is coextensive with the second FOV boundary at the window.

In another variation of this embodiment, a first distance between the first FOV boundary at the window and the second FOV boundary at the window is equal to a second distance between the first indicator boundary and the second indicator boundary.

In another variation of this embodiment, the FOV has a first FOV boundary and a second FOV boundary, diametrically opposed to and generally parallel to the first FOV boundary. The area indicated by the plurality of indicators has a first indicator boundary that is offset from the first FOV boundary at the window a first predetermined distance and a second indicator boundary, diametrically opposed and generally parallel to the first indicator boundary, that is offset from the second FOV boundary at the window a second predetermined distance.

In another variation of this embodiment, a first distance between the first FOV boundary at the window and the second FOV boundary at the window is greater than a second distance between the first indicator boundary and the second indicator boundary.

In another variation of this embodiment, the first indicator boundary and the second indicator boundary are both positioned between the first FOV boundary at the window and the second FOV boundary at the window.

In another variation of this embodiment, each of the plurality of indicators is one of a straight line or a generally L-shaped line.

In another variation of this embodiment, a central axis of the FOV is non-perpendicular to the window.

In another variation of this embodiment, an indicator transverse axis of the area indicated by the plurality of indicators is offset from a FOV transverse axis of the FOV at the window.

In another embodiment, the present invention is an indicia reader, including a housing having a window that is transparent and a generally planar surface that is opaque and surrounds the window. A camera is positioned within the housing and has a FOV directed through the window. A light source is positioned within the housing and is configured to project a plurality of indicators on the window. The plurality of indicators are positioned outside of a perimeter of the FOV at the window and arranged on the window to signify an area in which a document can be placed so that the document is within the FOV of the camera.

In a variation of this embodiment, the indicia reader includes a controller positioned within the housing and communicatively coupled to the camera and the light source. The controller is configured to alternate activating the light source to project the plurality of indicators and activating the camera to capture an image.

In another variation of this embodiment, the controller is configured to project the plurality of indicators in a first color with the document placed within the plurality of indicators and to project the plurality of indicators in a second color without the document placed within the plurality of indicators.

In another variation of this embodiment, the FOV has a first FOV boundary and a second FOV boundary, diametrically opposed to and generally parallel to the first FOV boundary. The area indicated by the plurality of indicators has a first indicator boundary that is coextensive with the first FOV boundary at the window and the area indicated by the plurality of indicators has a second indicator boundary, diametrically opposed and generally parallel to the first indicator boundary, that is coextensive with the second FOV boundary at the window.

In another variation of this embodiment, a first distance between the first FOV boundary at the window and the second FOV boundary at the window is equal to a second distance between the first indicator boundary and the second indicator boundary.

In another variation of this embodiment, the FOV has a first FOV boundary and a second FOV boundary, diametrically opposed to and generally parallel to the first FOV boundary. The area indicated by the plurality of indicators has a first indicator boundary that is offset from the first FOV boundary at the window a first predetermined distance and a second indicator boundary, diametrically opposed and generally parallel to the first indicator boundary, that is offset from the second FOV boundary at the window a second predetermined distance.

In another variation of this embodiment, a first distance between the first FOV boundary at the window and the second FOV boundary at the window is greater than a second distance between the first indicator boundary and the second indicator boundary.

In another variation of this embodiment, the first indicator boundary and the second indicator boundary are both positioned between the first FOV boundary at the window and the second FOV boundary at the window.

In another variation of this embodiment, each of the plurality of indicators is one of a straight line or a generally L-shaped line.

In another variation of this embodiment, a central axis of the FOV is non-perpendicular to the window.

In another variation of this embodiment, an indicator transverse axis of the area indicated by the plurality of indicators is offset from a FOV transverse axis of the FOV at the window.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a side view of a first example indicia reader;

FIG. 2 illustrates a top view of the indicia reader of FIG. 1;

FIG. 3 illustrates a side view of a second example indicia reader;

FIG. 4 illustrates a top view of the indicia reader of FIG. 3;

FIG. 5 illustrates a front view of the indicia reader of FIG. 3;

FIG. 6 illustrates a side view of a third example indicia reader;

FIG. 7 illustrates a top view of the indicia reader of FIG. 6;

FIG. 8 illustrates a side view of a fourth example indicia reader;

FIG. 9 illustrates a top view of the indicia reader of FIG. 8;

FIG. 10 illustrates a front view of the indicia reader of FIG. 8;

FIG. 11 illustrates a side view of a fifth example indicia reader;

FIG. 12 illustrates a top view of the indicia reader of FIG. 11;

FIG. 13 illustrates a side view of a sixth example indicia reader;

FIG. 14 illustrates a top view of the indicia reader of FIG. 13; and

FIG. 15 illustrates a front view of the indicia reader of FIG. 13.

Skilled artisans will appreciate that elements in the figures are illustrated for simplicity and clarity, have not necessarily been drawn to scale, and that details that are not necessary for an understanding of the invention or that render other details difficult to perceive may be omitted. For example, the dimensions of some of the elements in the figures may be exaggerated relative to other elements to help to improve understanding of embodiments of the present invention.

The apparatus components have been represented where appropriate by conventional symbols in the drawings, showing only those components and specific details that are pertinent to understanding the examples of the present invention so as not to obscure the disclosure with details that will be readily apparent to those of ordinary skill in the art having the benefit of the description herein.

### DETAILED DESCRIPTION

The example indicia readers disclosed herein include indicators on a surface of the housing surrounding a window, or on the window itself, which will indicate an area in which a user can position a document (e.g., an identification card) so that the document can be read by a camera within the housing without being cut off. In some implementations, the area indicated by the indicators can have the same depth measurement as the depth measurement of the field-of-view (FOV) of the camera at the window so that the area covers the entire FOV. In other implementations, the depth measurement of the area can be smaller than the depth measurement of the FOV of the camera at the window and the area positioned within the FOV of the camera at the window. In some implementations where the FOV of the camera is tilted (is not oriented perpendicular to the window) the area may not be positioned in the center of the window. In these implementations, because the FOV is tilted, without designating an area for the user to position the document, the document could be placed in the center of the window, which could position the document at least partially outside of the FOV and cut off a portion of the document.

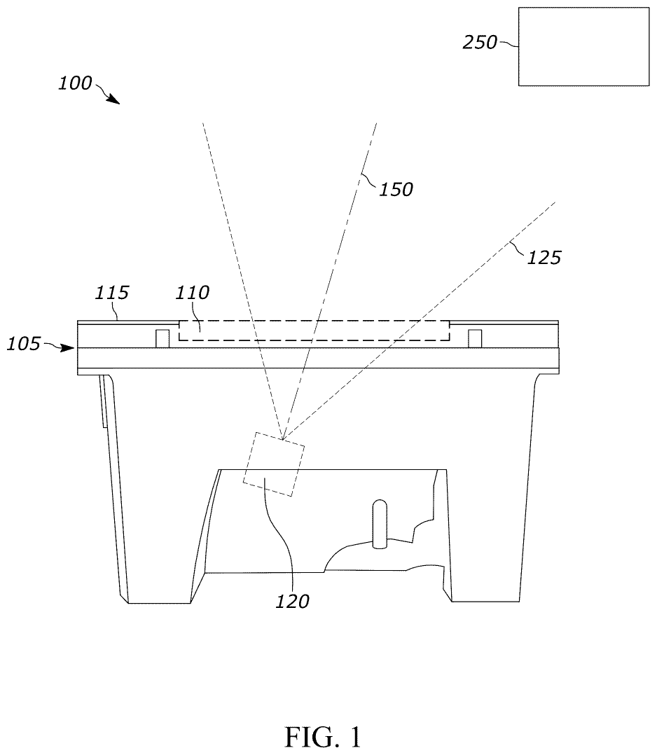

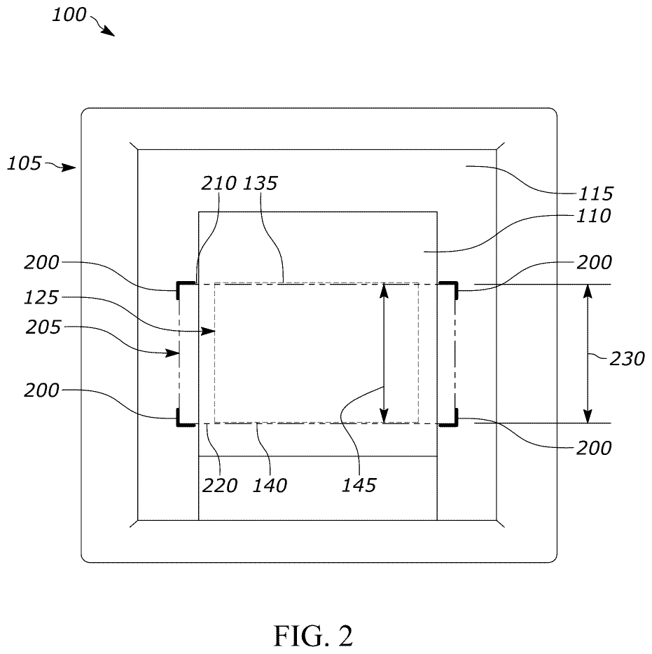

Referring to FIGS. 1-2, a first example of an indicia reader 100 is illustrated. In the implementation shown, indicia reader 100 is configured to be supported by a workstation, such as a checkout counter at a point-of-sale (POS) of a retail store, in a generally horizontal position. In other implementations, the indicia reader can be free-standing and configured to be oriented in a generally vertical position. Indicia reader 100 generally includes a housing 105 that includes a window 110 that is transparent and a generally planar surface 115 that is opaque and surrounds window 110. In the implementation shown, generally planar surface 115 is a top surface of housing 105. In other implementations, the generally planar surface can be part of a weigh platter, can be a front plate in vertically positioned implementations, etc. A camera 120 is positioned within housing 105 and has a FOV 125 that is directed through window 110. A central axis 150 of FOV 125 can extend generally in a direction that is non-perpendicular to window 110.

Referring to FIG. 2, a plurality of indicators 200 are located on generally planar surface 115 and are arranged on generally planar surface 115 to signify an area 205 in which a document 250 (e.g., an identification card) can be placed on window 110 so that document 250 is within FOV 125 of camera 120 and can be captured by camera 120 without cutting off any portion of document 250. Each of plurality of indicators 200 can be one of a straight line or a generally L-shaped line and can be printed on generally planar surface 115, etched into generally planar surface 115, embossed on generally planar surface 115, etc.

FOV 125 has a first FOV boundary 135 and a second FOV boundary 140, which is diametrically opposed to and generally parallel to first FOV boundary 135. In addition, area 205 indicated by plurality of indicators 200 has a first indicator boundary 210 and a second indicator boundary 220, which is diametrically opposed to and generally parallel to first indicator boundary 210. In the implementation shown, first indicator boundary 210 is coextensive with first FOV boundary 135 at window 110 and second indicator boundary 220 is coextensive with second FOV boundary 140 at window 110, such that a first distance 145 between first FOV boundary 135 at window 110 and second FOV boundary 140 at window 110 is generally equal to a second distance 230 between first indicator boundary 210 and second indicator boundary 220. In other implementations, the indicator boundaries can be inset from the FOV boundaries by predetermined distances, the distance between the FOV boundaries can be greater than the distance between the indicator boundaries, and the indicator boundaries can both be located between the FOV boundaries, as described in detail below.

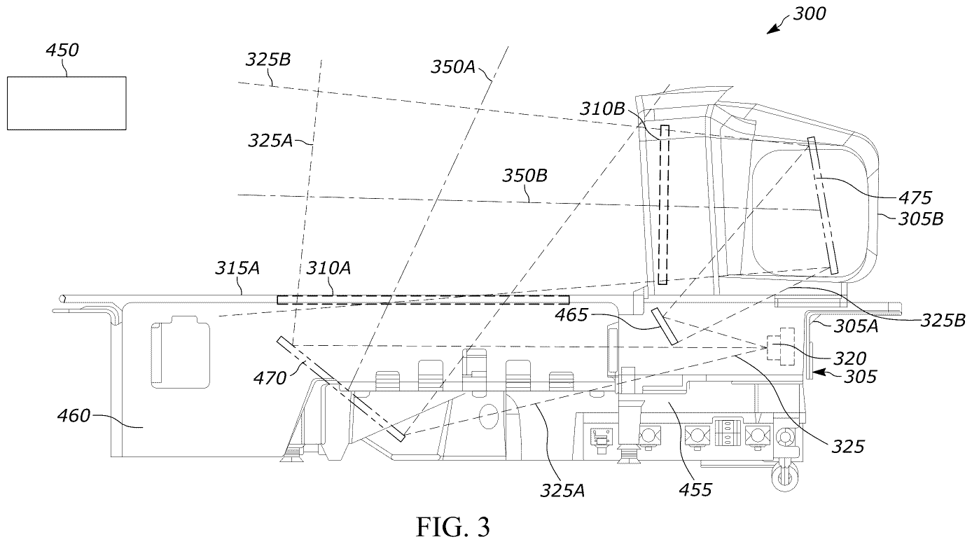

Referring to FIGS. 3-5, a second example of an indicia reader 300 is illustrated. In the implementation shown, indicia reader 300 is a bioptic indica reader and is configured to be supported by a workstation, such as a checkout counter at a POS of a retail store. Indicia reader 300 generally includes a housing 305 that includes a lower housing portion 305A and an upper housing portion 305B that extends above lower housing portion 305A. Housing 305 includes a window 310A in lower housing portion 305A that is transparent to allow a FOV 325A to pass through window 310A and a generally planar surface 315A that is opaque and surrounds window 310A. In the implementation shown, generally planar surface 315A is the upper surface of a platter or weigh platter. In addition, housing 305 includes a window 310B in upper housing portion 305B that is transparent to allow a FOV 325B to pass through window 310B and a generally planar surface 315B that is opaque and surrounds window 310B. FOV 325A and FOV 325B can intersect to define a product scanning region, where an object can be scanned for sale at the POS.

In some implementations, a perimeter frame 455 could at least partially surround and support indicia reader 300, a sheet metal frame 460 could be secured to the perimeter frame, and a scale assembly (not shown) could be positioned between indicia reader 300 and sheet metal frame 460 to engage the weigh platter to allow objects placed on the weigh platter to be weighed by the scale assembly, if used. Sheet metal frame 460 can be a single, unitary, integral part of can include multiple parts that are assembled together.

A camera 320 is positioned within housing 305 and has a FOV 325. A first mirror 465 is positioned within housing 305 in the path of FOV 325 and is configured to split FOV 325 into FOV 325A and FOV 325B. FOV 325A is redirected by a second mirror 470 in lower housing portion 305A through window 310A and FOV 325B is redirected by a third mirror 475 in upper housing portion 305B through window 310B.

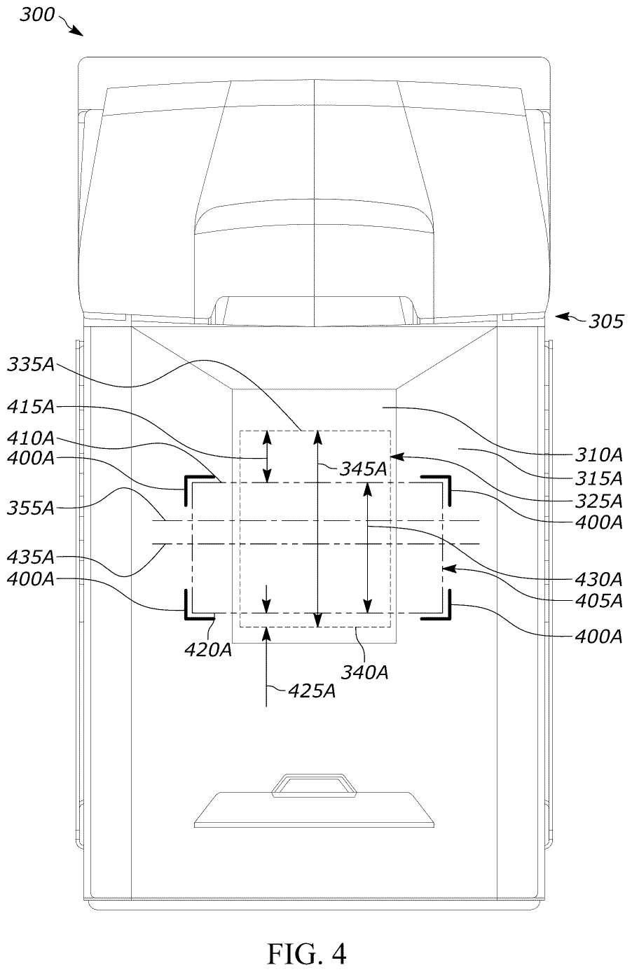

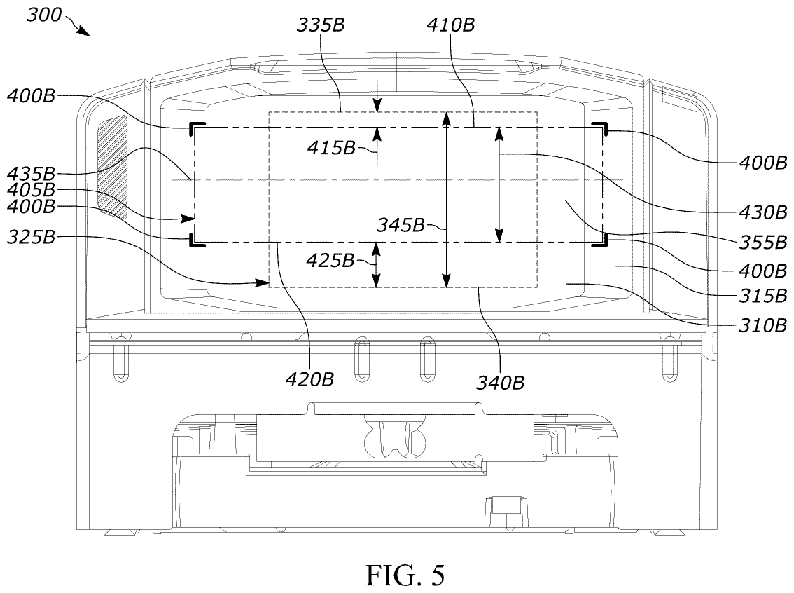

Referring to FIGS. 4-5, a plurality of indicators 400A can be located on generally planar surface 315A and arranged on generally planar surface 315A to signify an area 405A in which a document 450 (e.g., an identification card) can be placed on window 310A so that document 450 is within FOV 325A of camera 320 and can be captured by camera 320 without cutting off any portion of document 450. In addition to, or instead of, plurality of indicators 400A on generally planar surface 315A, a plurality of indicators 400B can be located on generally planar surface 315B and arranged on generally planar surface 315B to signify an area 405B in which document 450 can be placed on window 310B so that document 450 is within FOV 325B of camera 320 and can be captured by camera 320 without cutting off any portion of document 450. Each of plurality of indicators 400A, 400B can be one of a straight line or a generally L-shaped line and can be printed on generally planar surface 315A, 315B, etched into generally planar surface 315A, 315B, embossed on generally planar surface 315A, 315B, etc.

FOV 325A has a first FOV boundary 335A and a second FOV boundary 340A, diametrically opposed to and generally parallel to first FOV boundary 335A. Similarly, area 405A indicated by plurality of indicators 400A has a first indicator boundary 410A and a second indicator boundary 420A, diametrically opposed and generally parallel to first indicator boundary 410A. In the implementation shown, first indicator boundary 410A is offset from first FOV boundary 335A at window 310A a first predetermined distance 415A and second indicator boundary 420A is offset from second FOV boundary 340A at window 310A a second predetermined distance 425A, such that a first distance 345A between first FOV boundary 335A at window 310A and second FOV boundary 340A at window 310A is greater than a second distance 430A between first indicator boundary 410A and second indicator boundary 420A, and first indicator boundary 410A and second indicator boundary 420A are both positioned between first FOV boundary 335A at window 310A and second FOV boundary 340A at window 310A. In other embodiments, first FOV boundary 335A could be coextensive with first indicator boundary 410A and second FOV boundary 340A could be coextensive with second indicator boundary 420A, as discussed in detail above.

Similarly, FOV 325B has a first FOV boundary 335B and a second FOV boundary 340B, diametrically opposed to and generally parallel to first FOV boundary 335B. Similarly, area 405B indicated by plurality of indicators 400B has a first indicator boundary 410B and a second indicator boundary 420B, diametrically opposed and generally parallel to first indicator boundary 410B. In the implementation shown, first indicator boundary 410B is offset from first FOV boundary 335B at window 310B a first predetermined distance 415B and second indicator boundary 420B is offset from second FOV boundary 340B at window 310B a second predetermined distance 425B, such that a first distance 345B between first FOV boundary 335B at window 310B and second FOV boundary 340B at window 310B is greater than a second distance 430B between first indicator boundary 410B and second indicator boundary 420B, and first indicator boundary 410B and second indicator boundary 420B are both positioned between first FOV boundary 335B at window 310B and second FOV boundary 340B at window 310B. In other embodiments, first FOV boundary 335B could be coextensive with first indicator boundary 410B and second FOV boundary 340B could be coextensive with second indicator boundary 420B, as discussed in detail above.

In the implementation shown, a central axis 350A of FOV 325A can extend generally in a direction that is non-perpendicular to window 310A and an indicator transverse axis 435A of area 405A indicated by plurality of indicators 400A can be offset from a FOV transverse axis 355A of FOV 325A at window 310A to compensate for the directionality of FOV 325A. Similarly, a central axis 350B of FOV 325B can extend generally in a direction that is non-perpendicular to window 310B and an indicator transverse axis 435B of area 405B indicated by plurality of indicators 400B can be offset from a FOV transverse axis 355B of FOV 325B at window 310B to compensate for the directionality of FOV 325B.

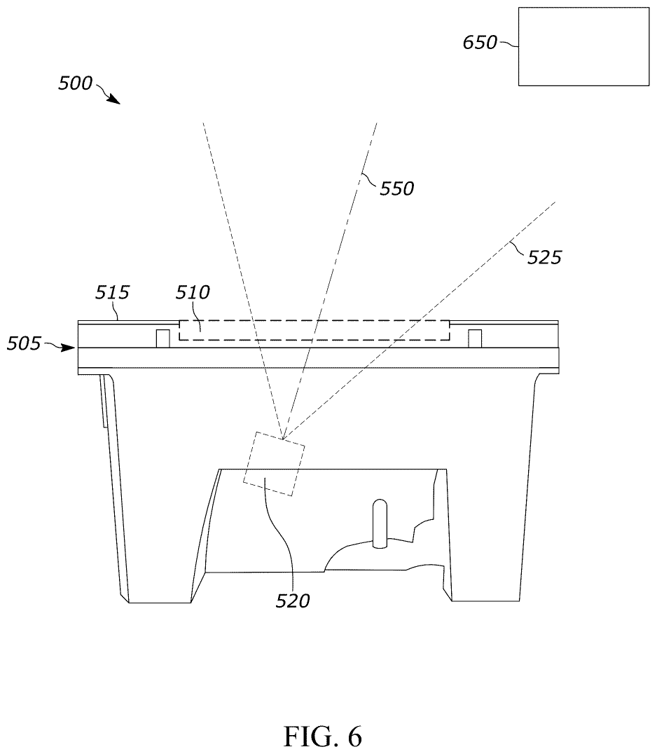

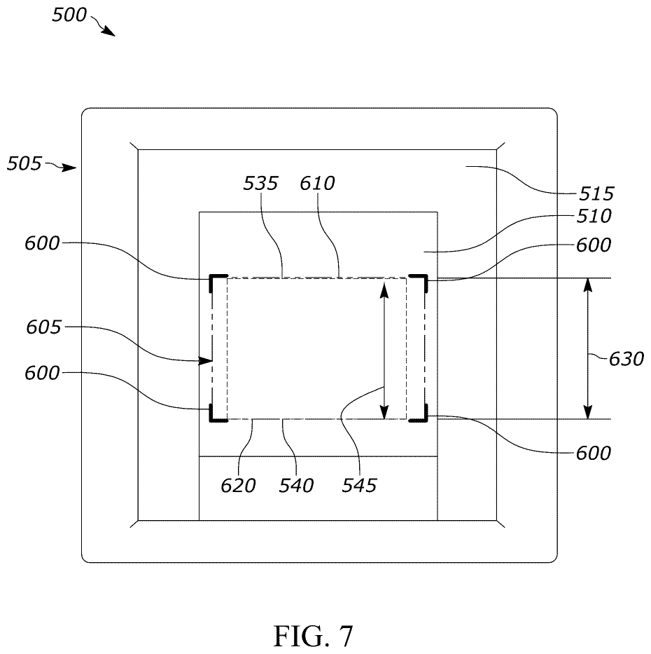

Referring to FIGS. 6-7, a third example of an indicia reader 500 is illustrated. In the implementation shown, indicia reader 500 is configured to be supported by a workstation, such as a checkout counter at a point-of-sale (POS) of a retail store, in a generally horizontal position. In other implementations, the indicia reader can be free-standing and configured to be oriented in a generally vertical position. Indicia reader 500 generally includes a housing 505 that includes a window 510 that is transparent and a generally planar surface 515 that is opaque and surrounds window 510. In the implementation shown, generally planar surface 515 is a top surface of housing 505. In other implementations, the generally planar surface can be part of a weigh platter, can be a front plate in vertically positioned implementations, etc. A camera 520 is positioned within housing 505 and has a FOV 525 that is directed through window 510. A central axis 550 of FOV 525 can extend generally in a direction that is non-perpendicular to window 510.

Referring to FIG. 7, a plurality of indicators 600 are located on window 510, are positioned outside of a perimeter 530 of FOV 525 at window 510, and are arranged on window 510 to signify an area 605 in which a document 650 (e.g., an identification card) can be placed on window 510 so that document 650 is within FOV 525 of camera 520 and can be captured by camera 520 without cutting off any portion of document 650. Each of plurality of indicators 600 can be one of a straight line or a generally L-shaped line and can be printed on window 510, etched into window 510, embossed on window 510, etc.

FOV 525 has a first FOV boundary 535 and a second FOV boundary 540, which is diametrically opposed to and generally parallel to first FOV boundary 535. In addition, area 605 indicated by plurality of indicators 600 has a first indicator boundary 610 and a second indicator boundary 620, which is diametrically opposed to and generally parallel to first indicator boundary 610. In the implementation shown, first indicator boundary 610 is coextensive with first FOV boundary 535 at window 510 and second indicator boundary 620 is coextensive with second FOV boundary 540 at window 510, such that a first distance 545 between first FOV boundary 535 at window 510 and second FOV boundary 540 at window 510 is generally equal to a second distance 630 between first indicator boundary 610 and second indicator boundary 620. In other implementations, the indicator boundaries can be inset from the FOV boundaries by predetermined distances, the distance between the FOV boundaries can be greater than the distance between the indicator boundaries, and the indicator boundaries can both be located between the FOV boundaries, as described in detail below.

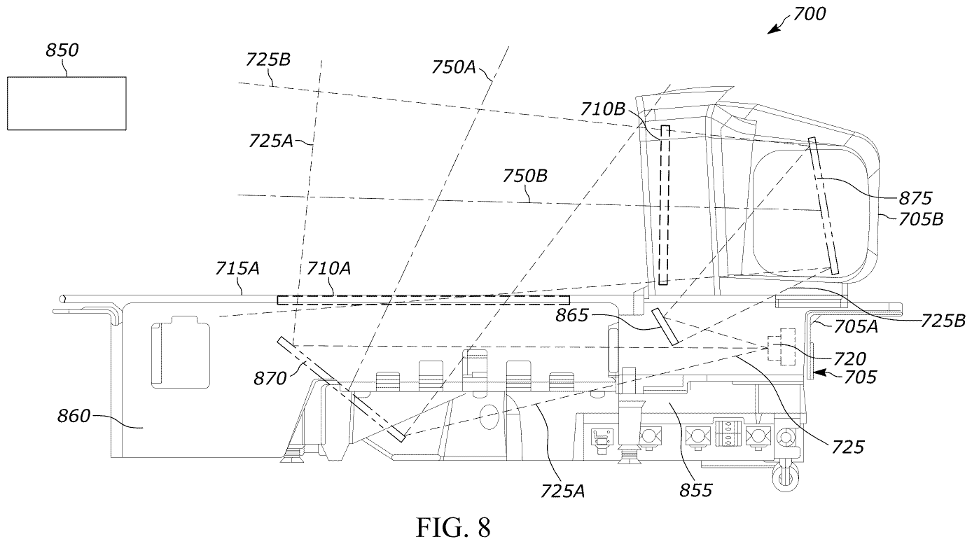

Referring to FIGS. 8-10, a fourth example of an indicia reader 700 is illustrated. In the implementation shown, indicia reader 700 is a bioptic indica reader and is configured to be supported by a workstation, such as a checkout counter at a POS of a retail store. Indicia reader 700 generally includes a housing 705 that includes a lower housing portion 705A and an upper housing portion 705B that extends above lower housing portion 705A. Housing 705 includes a window 710A in lower housing portion 705A that is transparent to allow a FOV 725A to pass through window 710A and a generally planar surface 715A that is opaque and surrounds window 710A. In the implementation shown, generally planar surface 715A is the upper surface of a platter or weigh platter. In addition, housing 705 includes a window 710B in upper housing portion 705B that is transparent to allow a FOV 725B to pass through window 710B and a generally planar surface 715B that is opaque and surrounds window 710B. FOV 725A and FOV 725B can intersect to define a product scanning region, where an object can be scanned for sale at the POS.

In some implementations, a perimeter frame 855 could at least partially surround and support indicia reader 700, a sheet metal frame 860 could be secured to the perimeter frame, and a scale assembly (not shown) could be positioned between indicia reader 700 and sheet metal frame 860 to engage the weigh platter to allow objects placed on the weigh platter to be weighed by the scale assembly, if used. Sheet metal frame 860 can be a single, unitary, integral part of can include multiple parts that are assembled together.

A camera 720 is positioned within housing 705 and has a FOV 725. A first mirror 865 is positioned within housing 705 in the path of FOV 725 and is configured to split FOV 725 into FOV 725A and FOV 725B. FOV 725A is redirected by a second mirror 870 in lower housing portion 705A through window 710A and FOV 725B is redirected by a third mirror 875 in upper housing portion 705B through window 710B.

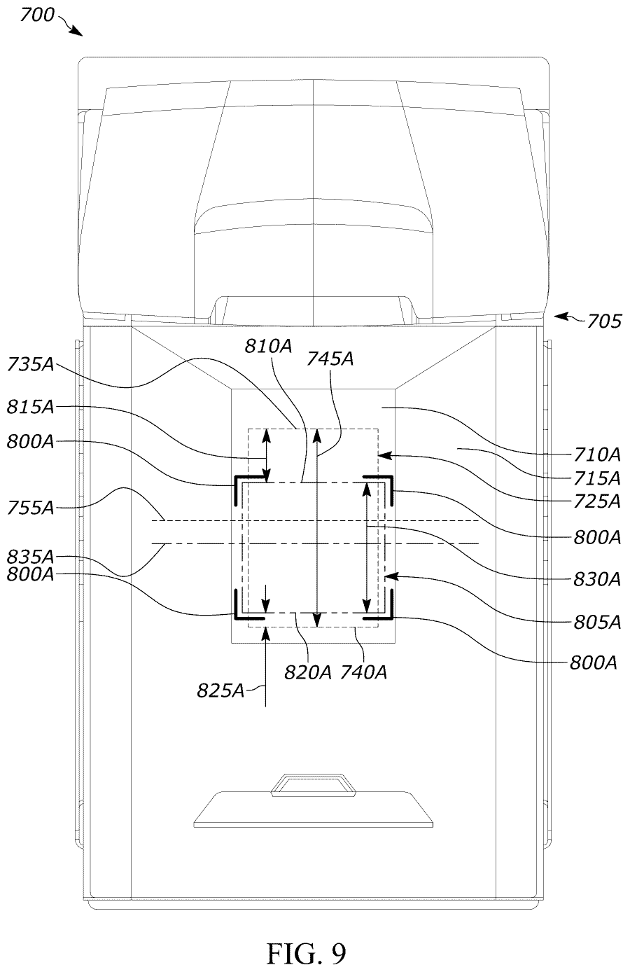

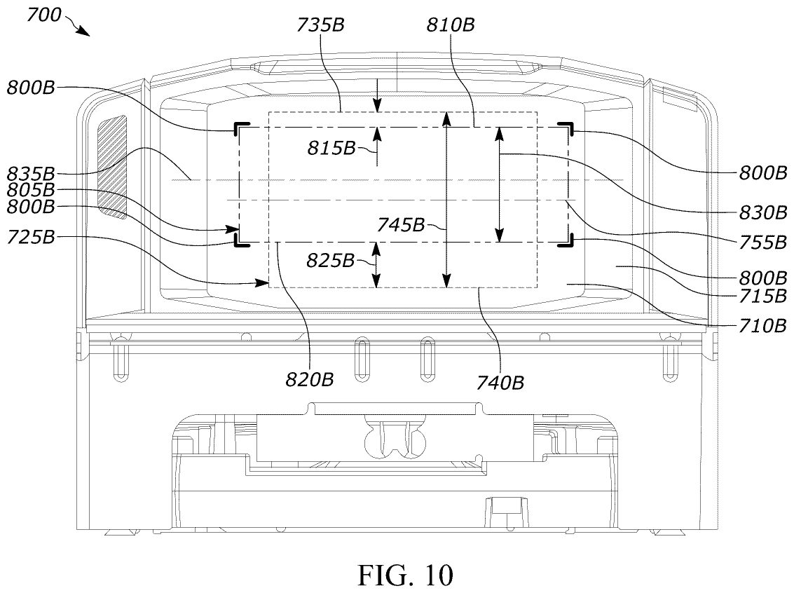

Referring to FIGS. 9-10, a plurality of indicators 800A can be located on window 710A, positioned outside of a perimeter 730A of FOV 725A at window 710A, and arranged on window 710A to signify an area 805A in which a document 850 (e.g., an identification card) can be placed on window 710A so that document 850 is within FOV 725A of camera 720 and can be captured by camera 720 without cutting off any portion of document 850. In addition to, or instead of, plurality of indicators 800A on window 710A, a plurality of indicators 800B can be located on window 710B, positioned outside of a perimeter 730B of FOV 725B at window 710B, and arranged on window 710B to signify an area 805B in which document 850 can be placed on window 710B so that document 850 is within FOV 725B of camera 720 and can be captured by camera 720 without cutting off any portion of document 850. Each of plurality of indicators 800A, 800B can be one of a straight line or a generally L-shaped line and can be printed on window 710A, 710B, etched into window 710A, 710B, embossed on window 710A, 710B, etc.

FOV 725A has a first FOV boundary 735A and a second FOV boundary 740A, diametrically opposed to and generally parallel to first FOV boundary 735A. Similarly, area 805A indicated by plurality of indicators 800A has a first indicator boundary 810A and a second indicator boundary 820A, diametrically opposed and generally parallel to first indicator boundary 810A. In the implementation shown, first indicator boundary 810A is offset from first FOV boundary 735A at window 710A a first predetermined distance 815A and second indicator boundary 820A is offset from second FOV boundary 740A at window 710A a second predetermined distance 825A, such that a first distance 745A between first FOV boundary 735A at window 710A and second FOV boundary 740A at window 710A is greater than a second distance 830A between first indicator boundary 810A and second indicator boundary 820A, and first indicator boundary 810A and second indicator boundary 820A are both positioned between first FOV boundary 735A at window 710A and second FOV boundary 740A at window 710A. In other embodiments, first FOV boundary 735A could be coextensive with first indicator boundary 810A and second FOV boundary 740A could be coextensive with second indicator boundary 820A, as discussed in detail above.

Similarly, FOV 725B has a first FOV boundary 735B and a second FOV boundary 740B, diametrically opposed to and generally parallel to first FOV boundary 735B. Similarly, area 805B indicated by plurality of indicators 800B has a first indicator boundary 810B and a second indicator boundary 820B, diametrically opposed and generally parallel to first indicator boundary 810B. In the implementation shown, first indicator boundary 810B is offset from first FOV boundary 735B at window 710B a first predetermined distance 815B and second indicator boundary 820B is offset from second FOV boundary 740B at window 710B a second predetermined distance 825B, such that a first distance 745B between first FOV boundary 735B at window 710B and second FOV boundary 740B at window 710B is greater than a second distance 830B between first indicator boundary 810B and second indicator boundary 820B, and first indicator boundary 810B and second indicator boundary 820B are both positioned between first FOV boundary 735B at window 710B and second FOV boundary 740B at window 710B. In other embodiments, first FOV boundary 735B could be coextensive with first indicator boundary 810B and second FOV boundary 740B could be coextensive with second indicator boundary 820B, as discussed in detail above.

In the implementation shown, a central axis 750A of FOV 725A can extend generally in a direction that is non-perpendicular to window 710A and an indicator transverse axis 835A of area 805A indicated by plurality of indicators 800A can be offset from a FOV transverse axis 755A of FOV 725A at window 710A to compensate for the directionality of FOV 725A. Similarly, a central axis 750B of FOV 725B can extend generally in a direction that is non-perpendicular to window 710B and an indicator transverse axis 835B of area 805B indicated by plurality of indicators 800B can be offset from a FOV transverse axis 755B of FOV 725B at window 710B to compensate for the directionality of FOV 725B.

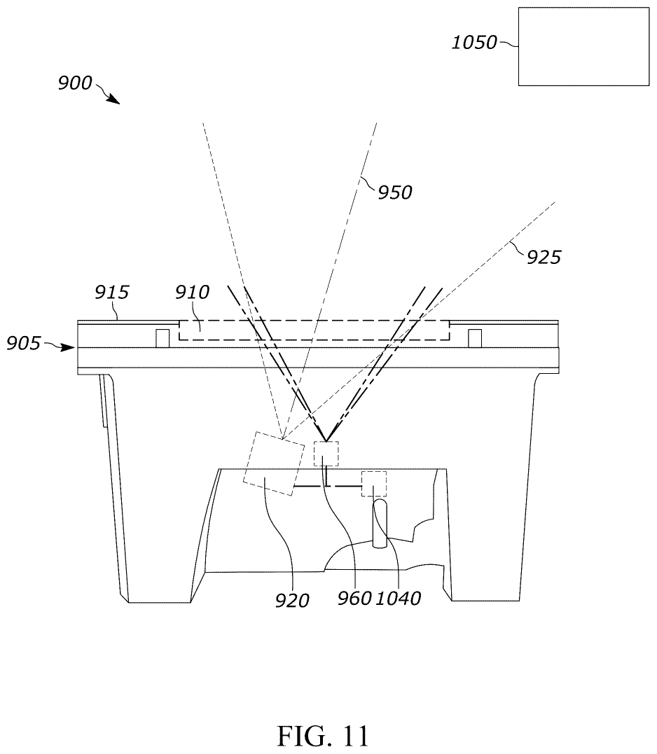

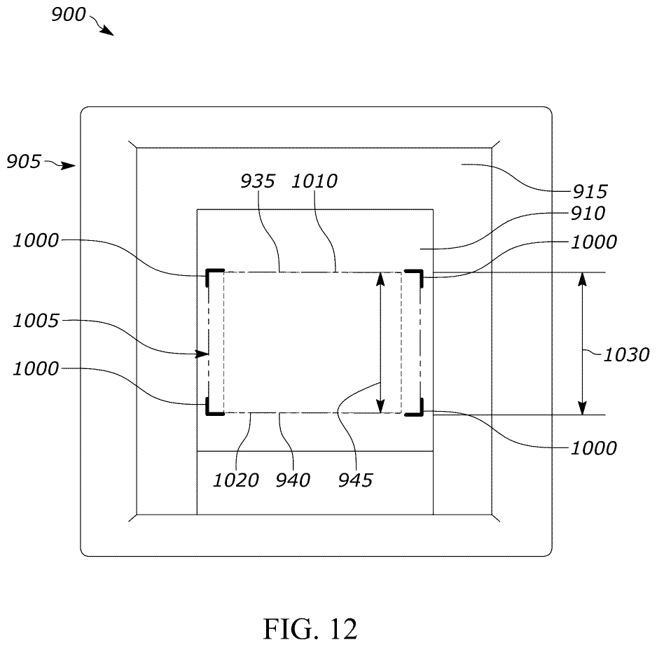

Referring to FIGS. 11-12, a fifth example of an indicia reader 900 is illustrated. In the implementation shown, indicia reader 900 is configured to be supported by a workstation, such as a checkout counter at a point-of-sale (POS) of a retail store, in a generally horizontal position. In other implementations, the indicia reader can be free-standing and configured to be oriented in a generally vertical position. Indicia reader 900 generally includes a housing 905 that includes a window 910 that is transparent and a generally planar surface 915 that is opaque and surrounds window 910. In the implementation shown, generally planar surface 915 is a top surface of housing 905. In other implementations, the generally planar surface can be part of a weigh platter, can be a front plate in vertically positioned implementations, etc. A camera 920 is positioned within housing 905 and has a FOV 925 that is directed through window 910. A central axis 950 of FOV 925 can extend generally in a direction that is non-perpendicular to window 910.

A light source 960 is positioned within housing 905 and is configured to project a plurality of indicators 1000 on window 910. In the implementation shown, plurality of indicators 1000 are positioned outside of a perimeter 930 of FOV 925 at window 910 and are arranged on window 910 to signify an area 1005 in which a document 1050 (e.g., an identification card) can be placed on window 910 so that document 1050 is within FOV 925 of camera 920 and can be captured by camera 920 without cutting off any portion of document 1050. Each of plurality of indicators 1000 projected by light source 960 on window 910 can be one of a straight line or a generally L-shaped line.

A controller 1040 can also be positioned within housing 905 and communicatively coupled to camera 920 and light source 960. Controller 1040 can be configured to alternate activating light source 960 to project plurality of indicators 1000 and activating camera 920 so that an image of plurality of indicators 1000 is not captured by camera 920. In some implementations, controller can be configured to project plurality of indicators 1000 in different colors depending on whether document 1050 is placed within plurality of indicators 1000. For example, controller 1040 can have light source 960 project plurality of indicators 1000 in a first color (e.g., green) with document 1050 placed within plurality of indicators 1000 and project plurality of indicators 1000 in a second color (e.g., red) without document 1050 placed within plurality of indicators 1000.

FOV 925 has a first FOV boundary 935 and a second FOV boundary 940, which is diametrically opposed to and generally parallel to first FOV boundary 935. In addition, area 1005 indicated by plurality of indicators 1000 has a first indicator boundary 1010 and a second indicator boundary 1020, which is diametrically opposed to and generally parallel to first indicator boundary 1010. In the implementation shown, first indicator boundary 1010 is coextensive with first FOV boundary 935 at window 910 and second indicator boundary 1020 is coextensive with second FOV boundary 940 at window 910, such that a first distance 945 between first FOV boundary 935 at window 910 and second FOV boundary 940 at window 910 is generally equal to a second distance 1030 between first indicator boundary 1010 and second indicator boundary 1020. In other implementations, the indicator boundaries can be inset from the FOV boundaries by predetermined distances, the distance between the FOV boundaries can be greater than the distance between the indicator boundaries, and the indicator boundaries can both be located between the FOV boundaries, as described in detail below.

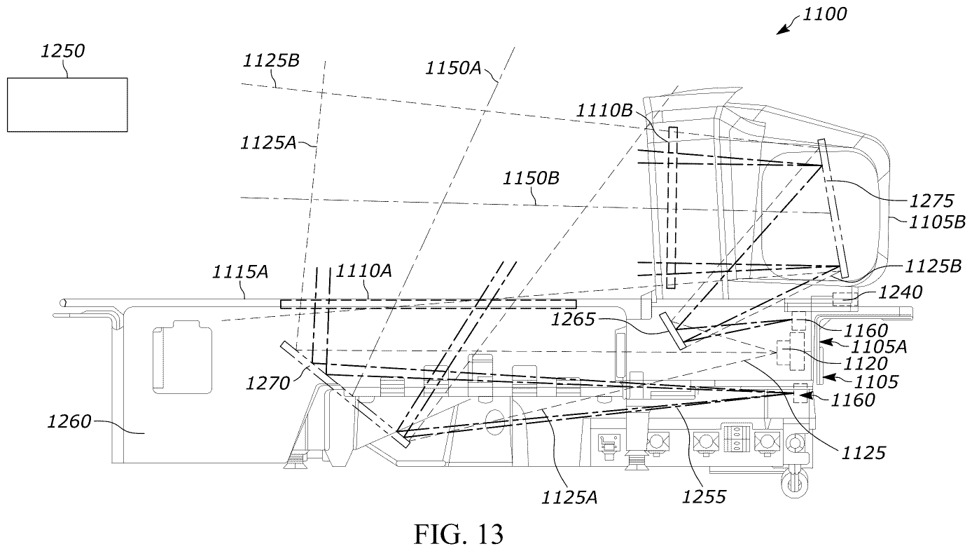

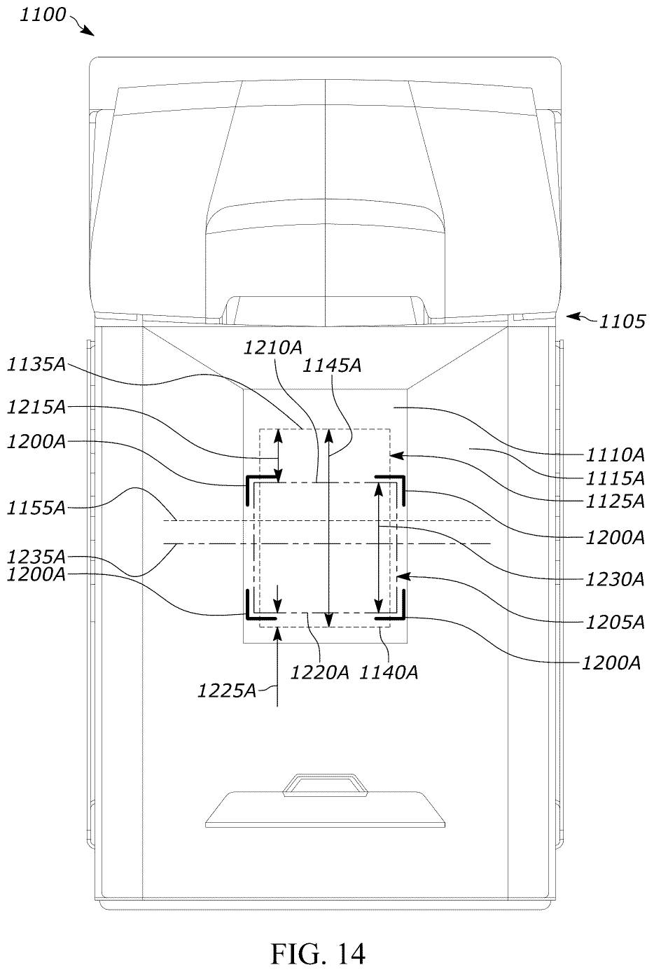

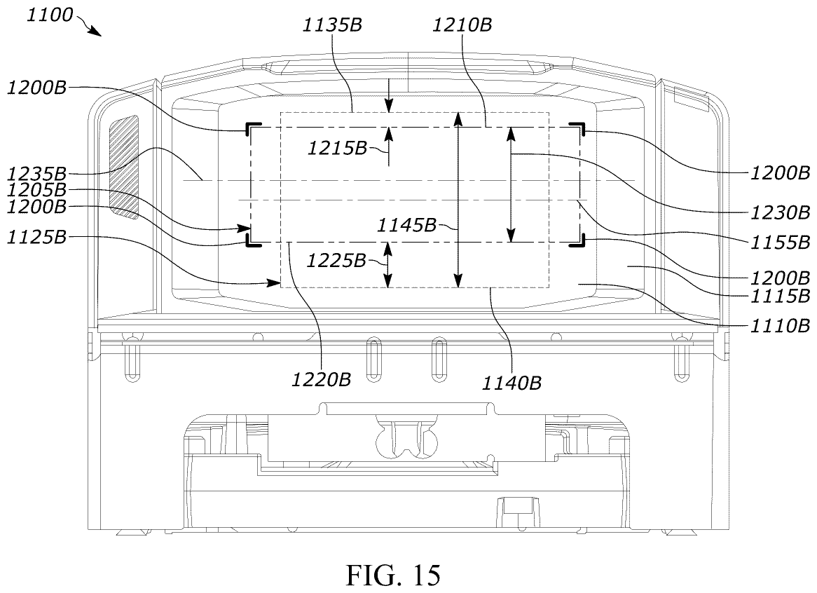

Referring to FIGS. 13-15, a sixth example of an indicia reader 1100 is illustrated. In the implementation shown, indicia reader 1100 is a bioptic indica reader and is configured to be supported by a workstation, such as a checkout counter at a POS of a retail store. Indicia reader 1100 generally includes a housing 1105 that includes a lower housing portion 1105A and an upper housing portion 1105B that extends above lower housing portion 1105A. Housing 1105 includes a window 1110A in lower housing portion 1105A that is transparent to allow a FOV 1125A to pass through window 1110A and a generally planar surface 1115A that is opaque and surrounds window 1110A. In the implementation shown, generally planar surface 1115A is the upper surface of a platter or weigh platter. In addition, housing 1105 includes a window 1110B in upper housing portion 1105B that is transparent to allow a FOV 1125B to pass through window 1110B and a generally planar surface 1115B that is opaque and surrounds window 1110B. FOV 1125A and FOV 1125B can intersect to define a product scanning region, where an object can be scanned for sale at the POS.

In some implementations, a perimeter frame 1255 could at least partially surround and support indicia reader 1100, a sheet metal frame 1260 could be secured to the perimeter frame, and a scale assembly (not shown) could be positioned between indicia reader 1100 and sheet metal frame 1260 to engage the weigh platter to allow objects placed on the weigh platter to be weighed by the scale assembly, if used. Sheet metal frame 1260 can be a single, unitary, integral part of can include multiple parts that are assembled together.

A camera 1120 is positioned within housing 1105 and has a FOV 1125. A first mirror 1265 is positioned within housing 1105 in the path of FOV 1125 and is configured to split FOV 1125 into FOV 1125A and FOV 1125B. FOV 1125A is redirected by a second mirror 1270 in lower housing portion 1105A through window 1110A and FOV 1125B is redirected by a third mirror 1275 in upper housing portion 1105B through window 1110B.

A light source 1160 is positioned within housing 1105 and is configured to project a plurality of indicators 1200A on window 1110A. In the implementation shown, plurality of indicators 1200A are positioned outside of a perimeter 1130A of FOV 1125A at window 1110A and arranged on window 1110A to signify an area 1205A in which a document 1250 (e.g., an identification card) can be placed on window 1110A so that document 1250 is within FOV 1125A of camera 1120 and can be captured by camera 1120 without cutting off any portion of document 1250. In addition to, or instead of, plurality of indicators 1200A on window 1110A, light source 1160 can be configured to project a plurality of indicators 1200B on window 1110B. In the implementation shown, plurality of indicators 1200B are positioned outside of a perimeter 1130B of FOV 1125B at window 1110B and arranged on window 1110B to signify an area 1205B in which document 1250 can be placed on window 1110B so that document 1250 is within FOV 1125B of camera 1120 and can be captured by camera 1120 without cutting off any portion of document 1250. Each of plurality of indicators 1200A, 800B can be one of a straight line or a generally L-shaped line.

A controller 1240 can also be positioned within housing 1105 and communicatively coupled to camera 1120 and light source 1160. Controller 1240 can be configured to alternate activating light source 1160 to project plurality of indicators 1200A and/or plurality of indicators 1200B and activating camera 1120 so that an image of plurality of indicators 1200A and/or plurality of indicators 1200B is not captured by camera 1120. In some implementations, controller can be configured to project plurality of indicators 1200A and/or plurality of indicators 1200B in different colors depending on whether document 1250 is placed within plurality of indicators 1200A and/or plurality of indicators 1200B. For example, controller 1240 can have light source 1160 project plurality of indicators 1200A and/or plurality of indicators 1200B in a first color (e.g., green) with document 1250 placed within plurality of indicators 1200A and/or plurality of indicators 1200B and project plurality of indicators 1200A and/or plurality of indicators 1200B in a second color (e.g., red) without document 1250 placed within plurality of indicators 1200A and/or plurality of indicators 1200B.

FOV 1125A has a first FOV boundary 1135A and a second FOV boundary 1140A, diametrically opposed to and generally parallel to first FOV boundary 1135A. Similarly, area 1205A indicated by plurality of indicators 1200A has a first indicator boundary 1210A and a second indicator boundary 1220A, diametrically opposed and generally parallel to first indicator boundary 1210A. In the implementation shown, first indicator boundary 1210A is offset from first FOV boundary 1135A at window 1110A a first predetermined distance 1215A and second indicator boundary 1220A is offset from second FOV boundary 1140A at window 1110A a second predetermined distance 1225A, such that a first distance 1145A between first FOV boundary 1135A at window 1110A and second FOV boundary 1140A at window 1110A is greater than a second distance 1230A between first indicator boundary 1210A and second indicator boundary 1220A, and first indicator boundary 1210A and second indicator boundary 1220A are both positioned between first FOV boundary 1135A at window 1110A and second FOV boundary 1140A at window 1110A. In other embodiments, first FOV boundary 1135A could be coextensive with first indicator boundary 1210A and second FOV boundary 1140A could be coextensive with second indicator boundary 1220A, as discussed in detail above.

Similarly, FOV 1125B has a first FOV boundary 1135B and a second FOV boundary 1140B, diametrically opposed to and generally parallel to first FOV boundary 1135B. Similarly, area 1205B indicated by plurality of indicators 1200B has a first indicator boundary 1210B and a second indicator boundary 1220B, diametrically opposed and generally parallel to first indicator boundary 1210B. In the implementation shown, first indicator boundary 1210B is offset from first FOV boundary 1135B at window 1110B a first predetermined distance 1215B and second indicator boundary 1220B is offset from second FOV boundary 1140B at window 1110B a second predetermined distance 1225B, such that a first distance 1145B between first FOV boundary 1135B at window 1110B and second FOV boundary 1140B at window 1110B is greater than a second distance 1230B between first indicator boundary 1210B and second indicator boundary 1220B, and first indicator boundary 1210B and second indicator boundary 1220B are both positioned between first FOV boundary 1135B at window 1110B and second FOV boundary 1140B at window 1110B. In other embodiments, first FOV boundary 1135B could be coextensive with first indicator boundary 1210B and second FOV boundary 1140B could be coextensive with second indicator boundary 1220B, as discussed in detail above.

In the implementation shown, a central axis 1150A of FOV 1125A can extend generally in a direction that is non-perpendicular to window 1110A and an indicator transverse axis 1235A of area 1205A indicated by plurality of indicators 1200A can be offset from a FOV transverse axis 1155A of FOV 1125A at window 1110A to compensate for the directionality of FOV 1125A. Similarly, a central axis 1150B of FOV 1125B can extend generally in a direction that is non-perpendicular to window 1110B and an indicator transverse axis 1235B of area 1205B indicated by plurality of indicators 1200B can be offset from a FOV transverse axis 1155B of FOV 1125B at window 1110B to compensate for the directionality of FOV 1125B.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An indicia reader, comprising:
a housing having a window that is transparent and a generally planar surface that is opaque and surrounds the window;
a camera positioned within the housing, the camera having a field-of-view (FOV) directed through the window; and
a plurality of indicators on the generally planar surface, the plurality of indicators arranged on the generally planar surface to signify an area in which a document can be placed so that the document is within the FOV of the camera,
wherein the FOV has a first FOV boundary and a second FOV boundary diametrically opposed to and generally parallel to the first FOV boundary,
wherein the first FOV boundary is parallel to and is a first distance away from a first edge of the generally planar surface,
wherein the second FOV boundary is parallel to and is a second distance away from a second edge of the generally planar surface, the first edge of the generally planar surface and the second edge of the generally planar surface being adjacent to the window, the first edge of the generally planar surface being parallel to the second edge of the generally planar surface, and
wherein the first distance of the first FOV boundary away from the first edge of the generally planar surface is different from the second distance of the second FOV boundary away from the second edge of the generally planar surface.

2. The indicia reader of claim 1, wherein: the FOV has a first FOV boundary and a second FOV boundary, diametrically opposed to and generally parallel to the first FOV boundary; the area indicated by the plurality of indicators has a first indicator boundary that is coextensive with the first FOV boundary at the window; and the area indicated by the plurality of indicators has a second indicator boundary, diametrically opposed and generally parallel to the first indicator boundary, that is coextensive with the second FOV boundary at the window.

3. The indicia reader of claim 2, wherein a first distance between the first FOV boundary at the window and the second FOV boundary at the window is equal to a second distance between the first indicator boundary and the second indicator boundary.

4. The indicia reader of claim 1, wherein: the FOV has a first FOV boundary and a second FOV boundary, diametrically opposed to and generally parallel to the first FOV boundary; the area indicated by the plurality of indicators has a first indicator boundary that is offset from the first FOV boundary at the window a first predetermined distance; and the area indicated by the plurality of indicators has a second indicator boundary, diametrically opposed and generally parallel to the first indicator boundary, that is offset from the second FOV boundary at the window a second predetermined distance.

5. The indicia reader of claim 4, wherein a first distance between the first FOV boundary at the window and the second FOV boundary at the window is greater than a second distance between the first indicator boundary and the second indicator boundary.

6. The indicia reader of claim 5, wherein the first indicator boundary and the second indicator boundary are both positioned between the first FOV boundary at the window and the second FOV boundary at the window.

7. The indicia reader of claim 1, wherein each of the plurality of indicators is one of a straight line or generally L-shaped line.

8. The indicia reader of claim 1, wherein a central axis of the FOV is non-perpendicular to the window.

9. The indicia reader of claim 8, wherein an indicator transverse axis of the area indicated by the plurality of indicators is offset from a FOV transverse axis of the FOV at the window.

10-29. (canceled)
